(19) United States
(12) Patent Application Publication
(10) Pub. No.: US 2026/0267574 A1
(43) Pub. Date: Sep. 10, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: SHOGO HIGASHI, Kanagawa (JP)

(21) Appl. No.: 19/553,059

(22) Filed: Feb. 27, 2026

(30) Foreign Application Priority Data
Mar. 4, 2025 (JP) 2025-033748

(51) Int. Cl. G06F 3/12

(52) U.S. Cl. CPC G06F 3/1229; G06F 3/121

(57) ABSTRACT

An information processing apparatus determines whether paper has been replenished in a paper feeding unit configured to feed paper to an image forming unit configured to form an image on the paper, determines a remaining amount of paper in the paper feeding unit, determines a type of the paper fed from the paper feeding unit, and notifies a user of a remaining amount of paper stacked in the paper feeding unit for each type and a switch in the type of the paper fed from the paper feeding unit in a case where it is determined that paper has been replenished in the paper feeding unit and a result of determining a type of the replenished paper in the paper feeding unit by the paper type determination unit is different from a type of the paper stacked in the paper feeding unit prior to the replenishment.

### BACKGROUND

### Field of the Technology

The present disclosure relates to an information processing apparatus, a method for controlling the information processing apparatus, and a storage medium.

### Description of the Related Art

There is a conventional image forming apparatus that performs control so that in a case where paper of a type different from a type of paper previously stacked in a paper feeding unit is fed during replenishment of paper in the paper feeding unit in a situation where a plurality of paper types is available for use in printing, this is notified to a user or printing is stopped. In such an image forming apparatus, the above-described control is realized by identifying the type of paper fed from the paper feeding unit using a sensor configured to detect a characteristic of paper and comparing the identification result with a paper type designated for the paper feeding unit. Japanese Patent Laid-Open No. 2007-62963 describes a technology for realizing the above-described control.

In another situation, paper of a type different from a type previously designated for a paper feeding unit may be replenished in the paper feeding unit due to a user operation error or the like, resulting in the paper feeding unit containing different types of paper. In such a situation, printing may be stopped as a result of applying the above-described control. However, even in that situation, it may be desirable to continue printing.

### SUMMARY

The present disclosure is directed to enabling printing to be performed more suitably even in a situation where a target paper feeding unit contains different types of paper.

According to an aspect of the present disclosure, an information processing apparatus includes at least one memory storing instructions, and at least one processor that, upon execution of the stored instructions, configures the at least one processor to operate as: a paper replenishment determination unit configured to determine whether paper has been replenished in a paper feeding unit configured to feed paper to an image forming unit configured to form an image on the paper, a remaining paper amount determination unit configured to determine a remaining amount of paper in the paper feeding unit, a paper type determination unit configured to determine a type of the paper fed from the paper feeding unit, and a notification unit configured to notify a user of a remaining amount of paper stacked in the paper feeding unit for each type and a switch in the type of the paper fed from the paper feeding unit in a case where the paper replenishment determination unit determines that paper has been replenished in the paper feeding unit and a result of determining a type of the replenished paper in the paper feeding unit by the paper type determination unit is different from a type of the paper stacked in the paper feeding unit prior to the replenishment.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example configuration of a printing processing system.

FIG. 2 is a functional block diagram illustrating an example functional configuration of a multi-function peripheral (MFP).

FIG. 3 is a diagram illustrating an example configuration of a digital front end (DFE).

FIG. 4 is a diagram illustrating an example program configuration of the MFP.

FIG. 5 is a diagram illustrating an example program configuration of the DFE.

FIG. 6 is a flowchart illustrating an example process of the MFP.

FIGS. 7A and 7B are diagrams illustrating example screens of the MFP.

FIG. 8 is a diagram illustrating an example screen of the MFP.

FIGS. 9A to 9C are diagrams illustrating example screens of the MFP.

FIG. 10 is a flowchart illustrating an example process of the DFE.

FIG. 11 is a diagram illustrating an example screen of the DFE.

FIGS. 12A and 12B are diagrams illustrating example screens of the DFE.

FIG. 13 is a flowchart illustrating an example process of the MFP.

FIGS. 14A to 14C are diagrams illustrating example screens of the MFP.

### DESCRIPTION OF THE EMBODIMENTS

Various embodiments of the present disclosure will be described in detail below with reference to the attached drawings.

It should be noted that in the present specification and the drawings, components having substantially the same functional configuration are denoted by the same reference numerals, and redundant descriptions thereof are omitted.

Further, the embodiments described below are not intended to limit the claimed invention, and not all combinations of features described in the embodiments are essential to the solution of the invention.

### First Embodiment

A first embodiment of the present disclosure will be described.

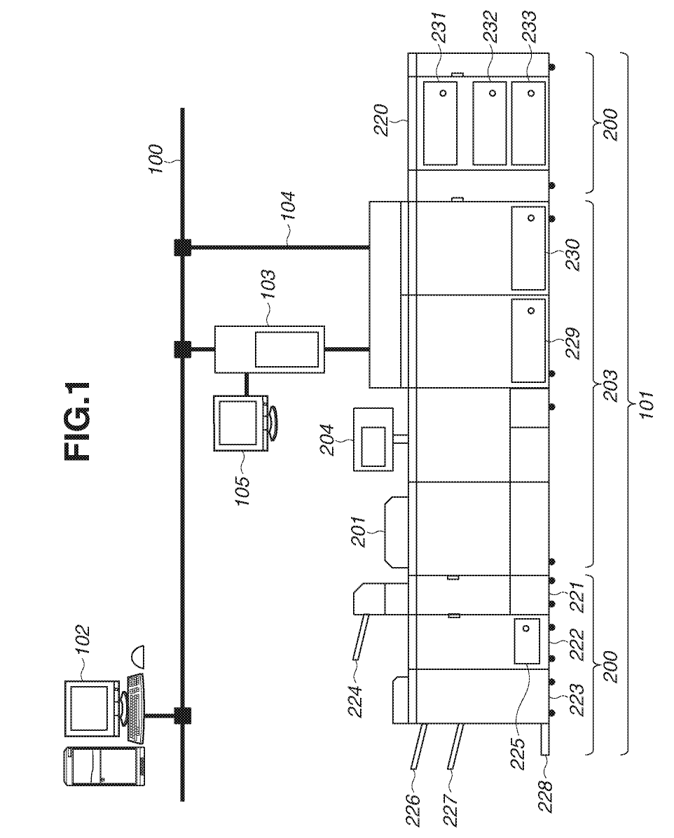

First, an example configuration of a printing processing system according to the present embodiment will be described with reference to FIG. 1. In the following various descriptions of the present embodiment, a multifunction peripheral (MFP) 101 is applied as an example of an image forming apparatus, and a personal computer (PC) 102 is applied as an example of an information processing apparatus. The MFP 101 and the PC 102 are connected to communicate with each other via a network 100.

It should be noted that while FIG. 1 illustrates an example case where the printing processing system includes a single information processing apparatus, this example is not intended to limit the configuration of the printing processing system according to the present embodiment. For example, the MFP 101 and each of a plurality of information processing apparatuses may be connected to communicate with each other via the network 100. Further, while FIG. 1 illustrates an example configuration including an image forming apparatus and an information processing apparatus, this is not intended to limit the configuration of the printing processing system according to the present embodiment. For example, the image forming apparatus may be configured as a printing processing system. Further, during execution of an image forming process executable by the MFP 101 alone, such as printing of a copy job or a saved job, an information processing apparatus connected to the network 100 may be a required configuration (for example, an information processing apparatus connected to the network 100 may be an unnecessary configuration).

First, the PC 102 will be described. The PC 102 is configured to execute various programs, such as an application program configured to input a print job. Further, various software such as a printer driver and workflow software are installed in the PC 102. The printer driver includes a function configured to convert print data into a printer language supported by the MFP 101. For example, in a case where printing is performed, a user may issue a print instruction from various applications. The printer driver, the workflow software, and the like are configured to convert data output by the application based on the print instruction into print data interpretable by the MFP 101 and transmit the print data to the MFP 101 connected to the network 100.

It should be noted that while the present embodiment describes an example case where a PC is applied as an information processing apparatus, a mobile information terminal may be applied, such as a smartphone or a tablet terminal. Further, a method for transmitting the print data to the image forming apparatus may be changed as necessary.

As a specific example, the print data may be transmitted to the image forming apparatus via a printing application or driver. Further, as another example, the print data may be transmitted to the image forming apparatus via a cloud server.

Next, the MFP 101 will be described. The MFP 101 includes reading and print functions. The reading function reads an image on a sheet, and the print function prints an image on a sheet. Further, the MFP 101 may include a post-processing function configured to bind a plurality of sheets on which an image is printed, align a plurality of sheets, and/or assign discharge destinations of a plurality of sheets to a plurality of trays. It should be noted that the sheets may include paper, such as plain paper, thick paper, and coated paper, a film, and the like.

It should be noted that while the MFP 101 is applied as an image forming apparatus in the various descriptions of the present embodiment, for example, a printer without the reading function or the like may be applied. According to the present embodiment, for example, the image forming apparatus includes various configurations described below.

A digital front end (DFE) 103 is an apparatus configured to mainly process print job data input to the MFP 101. Specifically, the DFE 103 provides a function as a type of server device configured to correct print job data input from the PC 102 or the like, perform editing, perform high-speed raster image processor (RIP) processing, store and manage print job data, and perform other operations.

The function of the DFE 103 may be realized as part of the functions of the MFP 101. As a specific example, the MFP 101 may be configured to provide the function of the DFE 103 to an external apparatus. In that case, the PC 102 may consider that the function of the MFP 101 is provided by the DFE 103 as a substitute via the network 100. The DFE 103 may include various input/output devices, such as a monitor 105, similar to those of the PC 102. Further, even in a case where the DFE 103, which is an associated device, is mounted, the MFP 101 may be configured to connect directly to the network 100 using a network cable 104 or the like.

The MFP 101 may be configured so that devices having a plurality of different roles are connected to one another and perform complicated sheet processing. Each component of the MFP 101 will be described.

A printer unit 203 forms (prints) an image on paper (sheet) fed from a paper feeding unit based on image data using toner. A configuration and operation principle of the printer unit 203 will be described.

Light, such as laser light, modulated based on image data is reflected as a scanning beam by a rotary polygon mirror (such as a polygon mirror), and the scanning beam irradiates a photosensitive drum. The laser light forms an electrostatic latent image on the photosensitive drum, and the electrostatic latent image is developed with toner. The resulting toner image is transferred onto a sheet placed on a transfer drum. The foregoing image forming process is sequentially performed with respect to yellow (Y), magenta (M), cyan (C), and black (K) toners, thereby forming a full-color image on the sheet. Further, a configuration may be employed that also allows a toner referred to as a spot color, a transparent toner, and the like to be transferred in addition to the four colors. The sheet on which the full-color image is formed on the transfer drum is conveyed to a fixing device. The fixing device includes a roller, a belt, and the like. The roller includes a built-in heat source, such as a halogen heater, and the toner on the sheet onto which the toner image has been transferred is melted and fixed to the sheet by heat and pressure.

Further, the MFP 101 according to the present embodiment is configured to select an appropriate printing speed mode applied by the printer unit 203 during printing based on a sheet type used during printing processing. Specifically, since the applicable printing speed for the fixing process is restricted depending on the sheet type, grammage, and the like, a process of switching the printing speed mode based on the sheet type and/or grammage may be applied. More specifically, a fixing temperature of an image forming unit may be changed, or various adjustments may be made as the speed is changed.

It should be noted that the printer unit 203 of the MFP 101 according to the present embodiment includes a scanner 201 and an operation unit 204 provided on an upper surface of the printer unit 203. The operation unit 204 provides various interfaces via which the user configures various settings for the printer unit 203 according to the present embodiment and performs operations. A function of the operation unit 204 may be performed by the monitor 105.

A high-capacity paper feeding device 220 is a paper feeding device configured to be attached to and detached from the printer unit 203. The paper feeding device 220 includes a plurality of paper feeding units (such as paper feeding units 231, 232, and 233). With the foregoing configuration, the printer unit 203 can print on a large number of sheets. Further, each paper feeding unit (such as the paper feeding unit 231, 232, or 233) is configured to be opened or closed, and the opening or closing of each paper feeding unit may be detected by a sensor or the like.

An inserter 221 is used to insert a sheet not subjected to image formation into a product of sheets created by the printer unit 203. In the example illustrated in FIG. 1, a device including a tray 224 is illustrated.

A punching device 222 is a device provided to perform processing, such as punching processing, on a sheet supplied by the printer unit 203 or the inserter 221.

In the example illustrated in FIG. 1, a device configured to allow replacement of an internal part referred to as a die is applied as the punching device 222. Accordingly, the punching device 222 includes a door 225 for die replacement.

A processing device 223 is provided to apply stapling processing to a bundle of a plurality of sheets. Examples of stapling types include corner binding, two-point binding, and saddle-stitch binding, and a binding process specified by the user is applied. A processed product to which corner binding or two-point binding is applied is discharged to a tray 226 or 227, whereas a processed produce to which saddle-stitch binding is applied is discharged to a tray 228.

The MFP 101 illustrated as an example in FIG. 1 may be divided into roughly three portions, with the printer unit 203 being boundaries. In FIG. 1, the device arranged on the right side of the printer unit 203 is referred to as the paper feeding device 220. The paper feeding device 220 mainly plays a role to continuously feed a sheet stored in the paper feeding device 220 to the printer unit 203 at an appropriate timing. Further, the paper feeding device 220 further performs another operation such as detection of the amount of remaining sheets stored in the paper feeding device 220. The printer unit 203 also includes paper feeding units (such as paper feeding units 229 and 230) configured to execute a function equivalent to the function of the paper feeding device 220. It should be noted that in the present disclosure, the paper feeding units 229 and 230 of the printer unit 203 are also referred to as the paper feeding device 220 in the description.

On the other hand, a device arranged on the left side of the printer unit 203 in FIG. 1 is referred to as a sheet processing device. Further, the device is also referred to as a sheet processing device or a post-processing apparatus.

The sheet processing device applies various types of processing or performs a process such as stacking on the sheet on which printing processing has been completed.

Hereinafter, the paper feeding device 220 and the sheet processing device may also be referred to collectively as a sheet processing device 200.

Next, an example of a configuration (mainly a software configuration) of the MFP 101 according to the present embodiment will be described.

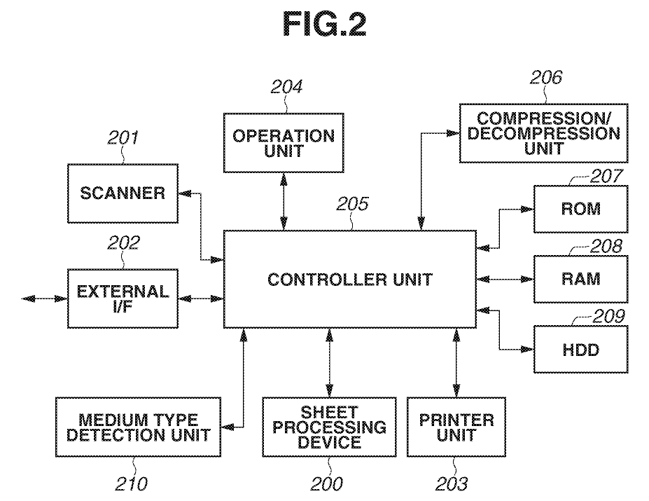

FIG. 2 is a functional block diagram illustrating an example of a functional configuration of the MFP 101 according to the present embodiment. It should be noted that as the blocks illustrated in FIG. 2 are grouped by system units, some portions do not strictly correspond to the units of the device configuration illustrated in FIG. 1.

The MFP 101 includes a non-volatile memory, such as a hard disk (hereinafter, also referred to as “HDD”) 209, configured to store a plurality of pieces of job data to be processed in the MFP 101. It should be noted that while an example of the MFP 101 using a hard disk is described in the present embodiment, the memory is not limited to a hard disk, and any other type of similar large-capacity and non-volatile storage device may be applied.

Further, the MFP 101 includes a copy function configured to store data received from the scanner 201 in the HDD 209, read the data from the HDD 209, and print the data using the printer unit 203. The MFP 101 further includes another function such as a print function configured to store job data received from an external apparatus via an external interface (external I/F) 202, which is an example of a communication unit, in the HDD 209, read the data from the HDD 209, and print the data using the printer unit 203. The MFP 101 is a multi-function peripheral (MFP) including the plurality of functions described above, and in the present disclosure, the MFP 101 may also be referred to as an image forming apparatus. It should be noted that the MFP 101 according to the present embodiment may be an image forming apparatus configured to perform color printing or an image forming apparatus configured to perform monochrome printing.

The scanner 201 scans an original document image, performs image processing on image data obtained by scanning the original document, and outputs the processed data.

The external I/F 202 transmits and receives image data and the like to and from a facsimile, a network connection device, an external dedicated apparatus, and the like.

The HDD 209 further stores various types of management information and the like that are permanently stored, changed, and managed by the MFP 101. Further, the MFP 101 includes the printer unit 203 configured to print the job data that is to be printed and stored in the HDD 209. The MFP 101 further includes the operation unit 204 including a display unit, which corresponds to an example of a user interface unit.

A controller unit (control unit) 205, which corresponds to an example of a control unit of the MFP 101, includes a central processing unit (CPU) (not illustrated) and comprehensively controls the processing, operations, and the like of the various units of the MFP 101.

A read-only memory (ROM) 207 stores various control programs configured to be executed by the controller unit 205 to realize the function of the MFP 101 according to the present embodiment, including a program for executing various processes of flowcharts described below and the like. The ROM 207 further stores a display control program or the like configured to display various user interface (UI) screens on the display unit of the operation unit 204, including a user interface screen (hereinafter, also referred to as “the UI screen”.

The CPU of the controller unit 205 reads a program stored in the ROM 207 and executes the read program, thereby realizing various operations of the MFP 101 according to the present embodiment.

The ROM 207 further stores another program such as a program configured to realize an operation of interpreting page description language (hereinafter, referrred to as “PDL” data received by the controller unit 205 from the external apparatus via the external I/F 202 and converting the PDL data into raster image data (bitmap image data). Similarly, the ROM 207 stores another program such as a program configured to interpret a print job received by the controller unit 205 from the external apparatus via the external I/F 202 and process the interpreted print job. These are processed by software.

The ROM 207 is a read-only memory and stores various programs in advance, including programs such as a boot sequence or font information and the programs described above.

A random access memory (RAM) 208 is a memory capable of both reading and writing and stores image data transmitted from the scanner 201 or the external I/F 202, various programs, setting information, and the like.

Further, the controller unit 205 further controls the operation of the sheet processing device 200. The sheet processing device 200 corresponds to the paper feeding device 220 and the sheet processing device described above with reference to FIG. 1.

Further, the HDD 209 stores image data compressed by a compression/decompression unit 206.

The HDD 209 is configured to hold a plurality of pieces of data, such as print data of a job to be processed. The controller unit 205 stores job data that is to be processed and is input via various input units, such as the scanner 201 or the external I/F 202, in the HDD 209, reads the data from the HDD 209, outputs the data to the printer unit 203, and prints the data. Further, the controller unit 205 may perform control so that the job data read from the HDD 209 is transmitted to the external apparatus via the external I/F 202. As described above, the controller unit 205 performs various output processes on job data that is to be processed and is stored in the HDD 209.

The compression/decompression unit 206 compresses or decompresses data such as image data stored in the RAM 208 or the HDD 209 using various compression schemes, such as Joint Bi-level Image Experts Group (JBIG) or Joint Photographic Experts Group (JPEG).

A medium type detection unit 210 is installed above a sheet conveyance path in the MFP 101, captures an image of fed paper using a sensor, and identifies a paper type from an acquired feature amount. Information indicating the identified paper type is stored in the RAM 208 via the controller unit 205, and when necessary, the information is transmitted to an external apparatus, such as the DFE 103, via the external I/F 202. It should be noted that the paper type according to the present disclosure refers to a type defined by categorizing combinations of surface characteristics (paper type) and grammage of paper using predetermined ranges.

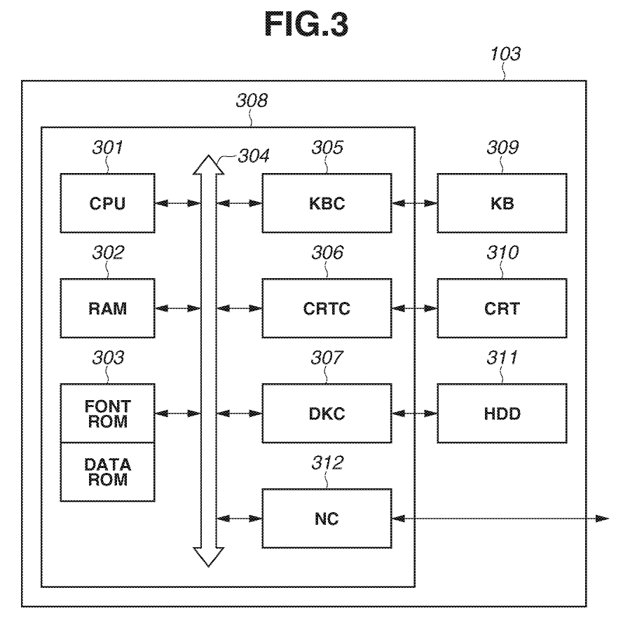

An example of a configuration of the DFE 103 according to the present embodiment will be described with reference to FIG. 3.

In FIG. 3, a CPU 301 executes a program stored in a program ROM of a ROM 303 or loaded from an HDD 311 into a RAM 302, such as an operating system (OS), a general application, or a bookbinding application. The ROM 303 is used as a font ROM and a data ROM. The RAM 302 is used as a main memory, work area, and the like of the CPU 301.

A keyboard controller (KBC) 305 controls input from a keyboard 309 or a pointing device (not illustrated).

A display controller 306 controls the display of a display unit 310.

A disk controller (DKC) 307 controls access to the HDD 311 and the like storing a boot program, various applications, font data, a user file, and the like.

A network controller (NC) 312 is connected to the network 100 and performs a process of controlling communication with another device connected to the network 100.

A bus 304 connects the CPU 301, the RAM 302, the ROM 303, various controllers, and the like and conveys a data signal and a control signal.

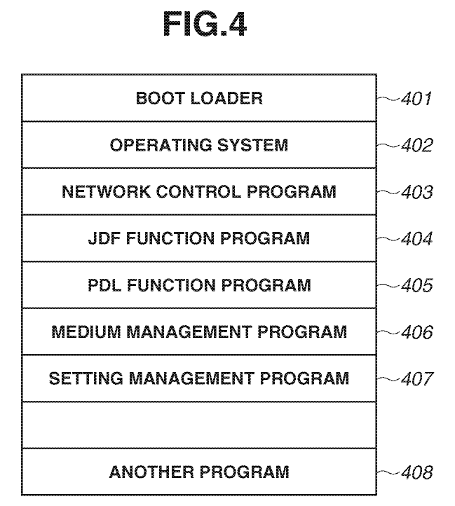

An example of a program of the MFP 101 according to the present embodiment will be described with reference to FIG. 4. Each program illustrated in FIG. 4 is stored in, for example, the ROM 207 and is read and executed by the controller unit 205 of the MFP 101.

A boot loader 401 is a program executed immediately after the MFP 101 is powered on.

These programs include a program for executing various activation sequences related to system activation.

An operating system 402 is a program configured to provide an execution environment for various programs configured to realize the function of the MFP 101. This program provides a function configured to manage mainly memory resources of the MFP 101, i.e., the ROM 207, the RAM 208, the HDD 209, and the like, a function configured to control basic input and output of other components illustrated in FIG. 2, and other functions.

A network control program 403 is a program executed to transmit or receive data to or from a device connected via a network. This program is used to perform a process of receiving a file to be printed, a process of transmitting data from an external apparatus, a process of transmitting or receiving a command, and other processes. The network control program 403 includes a device driver program configured to control the external I/F 202.

A job definition format (JDF) function program 404 is a program configured to realize a JDF print function executed by the controller unit 205 based on an instruction from the external I/F 202 in a case where JDF job data is received by the MFP 101 via the external I/F 202. In the JDF print function, the controller unit 205 sequentially instructs the devices illustrated in FIG. 2 to perform operations in an appropriate order based on a processing order and a processing condition described in the program. As a result, control is performed so that a JDF printing process is executed. The devices include the sheet processing device 200, the printer unit 203, the HDD 209, the compression/decompression unit 206, the RAM 208, and the like. Further, the JDF function program 404 includes a program configured to realize a process of analyzing JDF job data received via the external I/F 202, a process of determining whether an invalid setting is included in the JDF based on the result of the analysis process, a process of changing the setting to correct the invalid setting, and other processes.

A PDL function program 405 is a program configured to realize a PDL data expansion process and a print function executed by the controller unit 205 in a case where PDL data (image data to be printed) is received by the MFP 101 via the external I/F 202. In the PDL function executed by the controller unit 205, the controller unit 205 sequentially instructs the devices illustrated in FIG. 2 to perform operations in an appropriate order based on a processing order and a processing condition described in the program. As a result, control is performed so that a PDL printing process is executed. The devices include the sheet processing device 200, the printer unit 203, the HDD 209, the compression/decompression unit 206, the RAM 208, and the like. Further, the PDL function program 405 according to the present embodiment is configured to operate together with the JDF function program 404 as an analyzing unit configured to analyze various job setting formats during execution of printing processing.

A medium management program 406 is a program configured to realize a management function associated with paper available to the MFP 101. Paper association information managed by the medium management program 406 is stored in the HDD 209. The medium management program 406 makes it possible to provide a paper management function configure to register new paper, delete unnecessary paper, and perform other operations. Further, the medium management program 406 further includes a function configured to change a registered paper setting, adjust unadjusted paper and re-register it as adjusted paper, and perform other operations. Further, the medium management program 406 may include a management function configured to export paper information to an external device, such as the PC 102, from the MFP 101 via the external I/F 202, import paper information from the PC 102, or other operations. Further, the paper association information managed by the medium management program 406 may include printing speed information processible during printing as information to be managed. Further, the medium management program 406 further includes a function configured to control and manage the state of the paper feeding device 220, control a paper type setting in the paper feeding device 220, and other operations.

According to the present embodiment, the JDF function program 404 and the PDL function program 405 operate in conjunction with the medium management program 406, identify a paper type used by a job to be printed and a print condition, select an appropriate printing speed, and perform control.

A setting management program 407 is a program configured to configure various settings for the components of the MFP 101. For example, an instruction to the setting management program 407 is issued via the operation unit 204 or is issued remotely from an external system, such as the PC 102 or the DFE 103, via the external I/F 202.

Another program 408 schematically illustrates a program that may be executed by the MFP 101, is stored in the ROM 207, and is not included in any of the above-described programs. It should be noted that as the program is not essential for explaining the effect of the present disclosure, descriptions of the program are omitted.

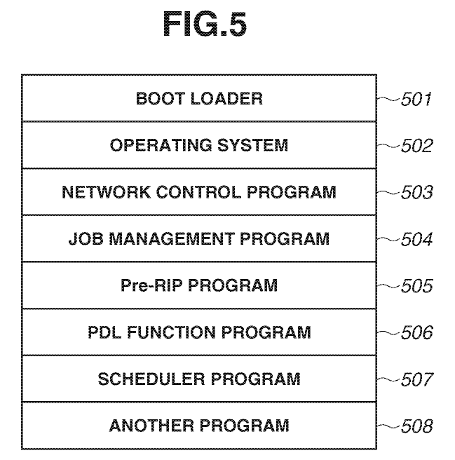

An example of a configuration of a program included in the DFE 103 according to the present embodiment will be described with reference to FIG. 5.

A boot loader 501 is a program executed immediately after the DFE 103 is powered on.

These programs include a program for executing various activation sequences related to system activation.

An operating system 502 is a program configured to provide an execution environment for various programs configured to realize the function of the DFE 103. This program provides a function configured to manage memory resources of the DFE 103, i.e., the ROM 303, the RAM 302, the HDD 311, and the like.

A network control program 503 is a program executed to transmit or receive data to a device connected via a network. The network control program 503 is used to transmit print job data to the MFP 101 and instruct the MFP 101 to perform printing processing. Further, the network control program 503 is also used to receive print data from an external apparatus, such as the PC 102, transmit a status, and perform other operations.

A job management program 504 is a program configured to manage a job transmitted from the DFE 103 to the MFP 101. A job list is managed in order of transmission, and a process of reordering the jobs, suspending a job, cancelling a job, changing a setting for the job, or the like may be executed through the job management program 504. Further, the job management program 504 operates in conjunction with a PDL function program 506, a scheduler program 507, a pre-RIP program 505, and the like described below and performs a series of job management and job execution control processes as the DFE 103 in a case where the DFE 103 receives a print job from an external apparatus, such as the PC 102.

The pre-RIP program 505 is a program configured to analyze configuration information of print job data in a case where the DFE 103 receives the print job data from the PC 102 via the network control program 503. Specifically, the pre-RIP program 505 collects the number of pages of the print job data, page size, sheet information for each page, various types of setting information, and the like and transmits the collected information to the job management program 504.

The PDL function program 506 is a program configured to perform a process of expanding print job data. The PDL function program 506 is executed in a case where the DFE 103 receives a print job from the PC 102 through the network control program 503. The expanded data is converted into a format appropriate for printing, and the converted data is transmitted to the MFP 101 through the network control program 503, thereby instructing the MFP 101 to perform printing processing.

The scheduler program 507 is a program configured to present progress status information indicating each job registered in the job management program 504 to the user. For example, the scheduler program 507 displays a job duration, a time at which a paper-out condition occurs, and other time information on the display unit 310 in a format that enable chronological tracking of the information, thereby presenting the information to the user. This makes it possible for the user of the MFP 101 and the DFE 103 to efficiently replenish paper and establish a production plan for product generation.

Another program 508 schematically illustrates a program that is included in the DFE 103 and is not included in any of the above-described programs. It should be noted that as the program is not essential for explaining the effect of the present disclosure, descriptions of the program are omitted.

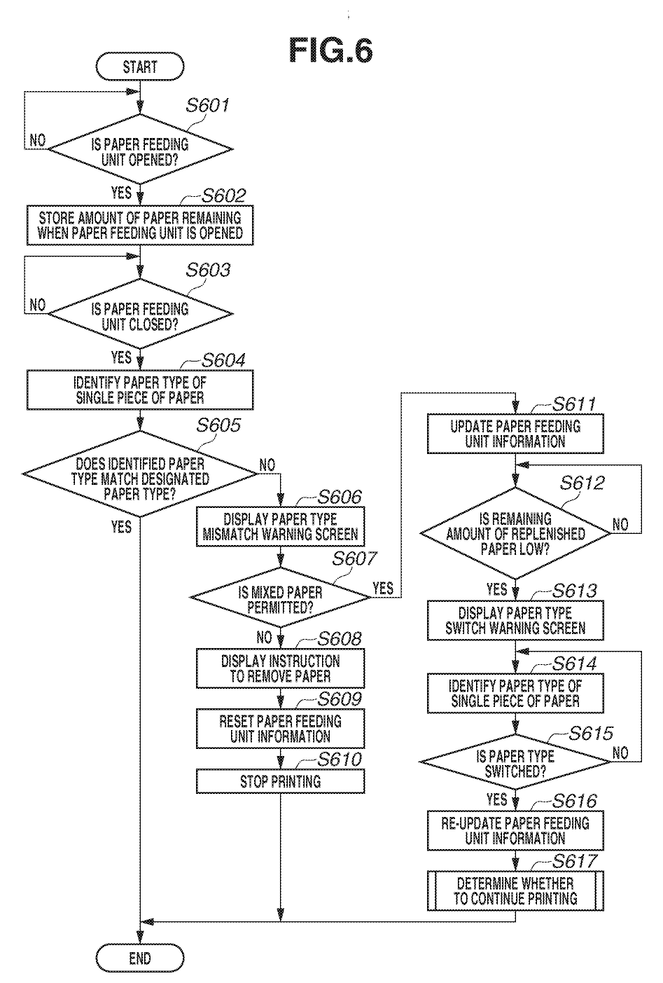

An example of a process of the MFP 101 according to the present embodiment will be described with reference to FIG. 6, focusing on a process in which the medium management program 406 determines whether a plurality of paper types is mixed within the same paper feeding unit of the paper feeding device 220, and controls a state where a plurality of paper types is mixed. For example, the series of processes illustrated in FIG. 6 is started in a case where a user operation is performed to enable a setting configured to determine whether a plurality of paper types is mixed with respect to the medium management program 406 of the MFP 101. Further, as long as the setting configured to determine whether a plurality of paper types is mixed is enabled, the series of processes illustrated in FIG. 6 is re-started after the process ends. Further, the series of processes illustrated in FIG. 6 is realized by the controller unit 205 of the MFP 101 by reading the medium management program 406 stored in the ROM 207 or the like and executing the medium management program 406. Accordingly, while the controller unit 205 is the entity that actually performs the processes illustrated in FIG. 6, for convenience, the medium management program 406 will be described as the entity of each process.

In step S601, the medium management program 406 determines whether a paper feeding unit is opened.

Unless the medium management program 406 determines that a paper feeding unit is opened in step S601, the medium management program 406 repeats the process of step S601.

Then, in a case where the medium management program 406 determines that a paper feeding unit is opened (YES in step S601), the processing proceeds to step S602.

In step S602, the medium management program 406 stores the amount of paper remaining in the paper feeding unit at the time the paper feeding unit is opened (in other words, the amount of paper remaining in the paper feeding unit prior to paper replenishment). At that time, the information indicating the amount of remaining paper is saved in a non-volatile storage area, such as the HDD 209, because the information should be held even in a case where the MFP 101 is re-activated. It should be noted that the information indicating the amount of paper remaining in the paper feeding unit is confirmed and updated not only at the time the paper feeding unit is opened but also each time the state of the paper feeding unit is updated in response to paper being fed from the paper feeding unit or in response to other events.

In step S603, the medium management program 406 determines whether the paper feeding unit is closed.

Unless the medium management program 406 determines that the paper feeding unit is closed in step S603, the medium management program 406 repeats the process of step S603.

Then, in a case where the medium management program 406 determines that the paper feeding unit is closed (YES in step S603), the processing proceeds to step S604.

It should be noted that while whether paper replenishment has been performed is determined based on whether the paper feeding unit has been opened and closed, as described in the processes of steps S601 to S603 in the present embodiment, in addition to the foregoing control, another control may be applied in which whether paper replenishment has been performed is determined based on an increase in the amount of paper remaining in the paper feeding unit upon closing the paper feeding unit.

In step S604, the medium management program 406 causes the MFP 101 to feed a single piece of paper and identifies the type of the paper. At that time, the target paper is passed through the medium type detection unit 210, and the type of the paper is identified based on a detection result obtained by the medium type detection unit 210 for the paper. It should be noted that the single piece of paper for paper type identification may be fed upon execution of a print job or closure of the paper feeding unit.

In step S605, the medium management program 406 determines whether the paper type identified in step S604 matches the paper type designated for the paper feeding unit.

In a case where the medium management program 406 determines that the identified paper type matches the paper type designated for the paper feeding unit (YES in step S605), the medium management program 406 ends the series of processes illustrated in FIG. 6.

On the other hand, in a case where the medium management program 406 determines that the identified paper type does not match the paper type designated for the paper feeding unit (NO in step S605), the processing proceeds to step S606.

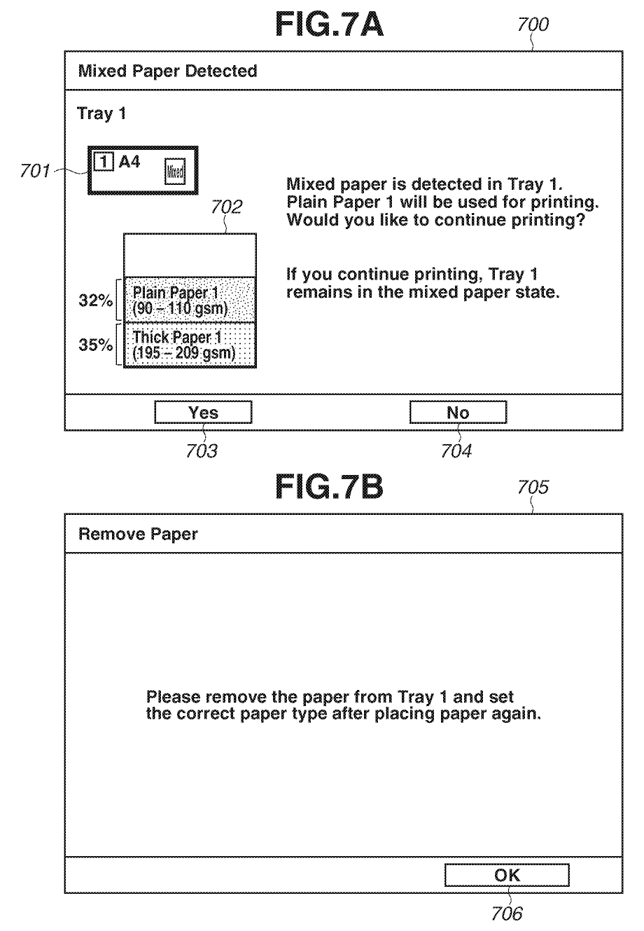

In step S606, the medium management program 406 displays a screen indicating the paper type mismatch. An example of the screen will be described in detail below with reference to FIG. 7A.

In step S607, the medium management program 406 receives an input operation from the user via the screen displayed in step S606 to select whether to permit mixed paper.

In a case where the medium management program 406 determines that an input operation indicating that mixed paper is permitted is received (YES in step S607), the processing proceeds to step S611.

On the other hand, in a case where the medium management program 406 determines that an input operation indicating that mixed paper is not permitted is received (NO in step S607), the processing proceeds to step S608.

In step S608, the medium management program 406 displays a screen to instruct the user to remove the paper from the paper feeding unit and configure the paper setting again, and receives an input operation from the user indicating acknowledgement of the instruction. An example of the screen will be described in detail below with reference to FIG. 7B.

In step S609, the medium management program 406 resets the information indicating the target paper feeding unit.

In step S610, the medium management program 406 instructs the job management program 504 to stop the print job. Upon receiving the instruction from the medium management program 406, the job management program 504 stops the print job in a case where the print job is being executed.

Then, the medium management program 406 ends the series of processes illustrated in FIG. 6.

In step S611, the medium management program 406 updates paper type information about the paper feeding unit to the state where the plurality of types is mixed.

In step S612, the medium management program 406 determines whether the remaining amount of the newly replenished paper becomes low (for example, the remaining amount of the paper becomes less than or equal to a threshold) and confirmation is required to switch the paper type to the type of paper stacked prior to the replenishment. Specifically, the medium management program 406 determines whether the remaining amount of the newly replenished paper becomes less than or equal to a minimum detectable unit of stacking amount by the paper feeding unit. It should be noted that the remaining amount of the newly replenished paper can be calculated based on, for example, the amount of paper remaining in the paper feeding unit prior to replenishment of the paper for which the information is stored in step S602 and the current amount of paper remaining in the paper feeding unit.

Unless the medium management program 406 determines in step S612 that the remaining amount of the newly replenished paper becomes less than or equal to the minimum detectable unit of stacking amount by the paper feeding unit, the medium management program 406 repeats the process of step S612.

Then, in a case where the medium management program 406 determines that the remaining amount of the newly replenished paper becomes less than or equal to the minimum detectable unit of stacking amount by the paper feeding unit (YES in step S612), the processing proceeds to step S613.

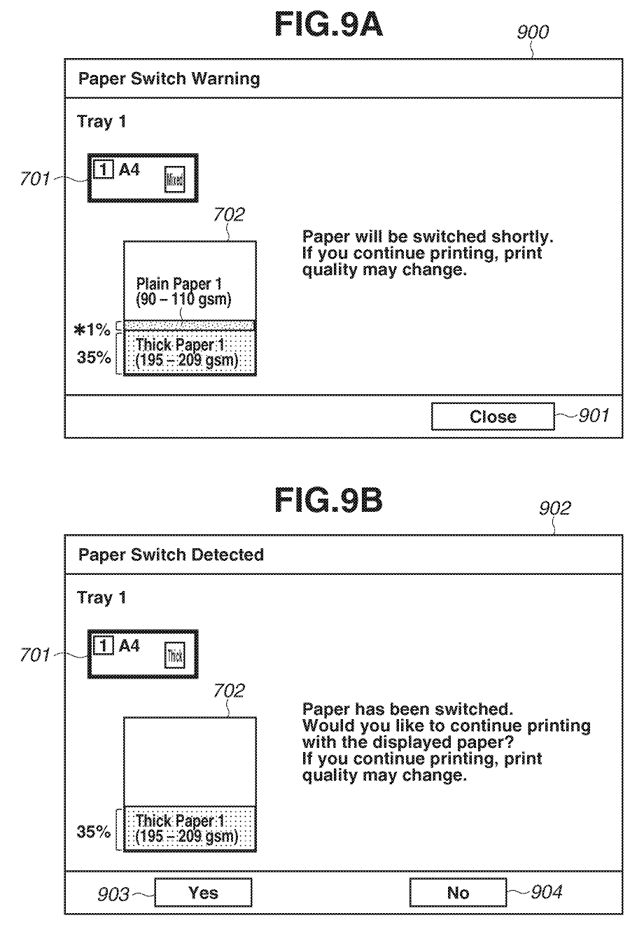

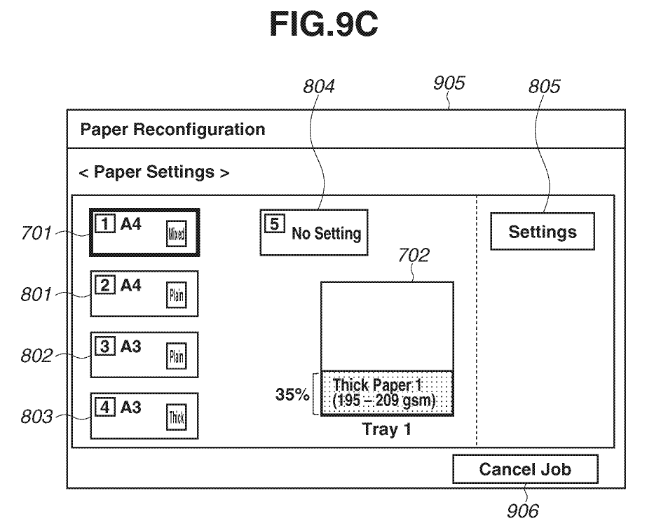

In step S613, the medium management program 406 displays a screen configured to notify the user that the paper type will be switched shortly (in other words, a screen configured to warn the user of the occurrence of a paper type change). An example of the screen will be described in detail below with reference to FIG. 9A.

In step S614, the medium management program 406 causes the MFP 101 to feed a single piece of paper and identifies the type of the paper.

In step S615, the medium management program 406 determines whether the paper type identified in step S614 matches the type of the replenished paper, thereby determining whether the paper type is switched.

In a case where the medium management program 406 determines that the identified paper type matches the type of the replenished paper, the medium management program 406 determines that the paper type is not switched (NO in step S615), and the processing proceeds to step S614. In that case, the processes from step S614 are performed again.

On the other hand, in a case where the medium management program 406 determines that the identified paper type does not match the type of the replenished paper, the medium management program 406 determines that the paper type is switched (YES in step S615), and the processing proceeds to step S616.

In step S616, the medium management program 406 updates the paper type information about the paper feeding unit to the state prior to the replenishment of the paper of the type different from the designated paper type.

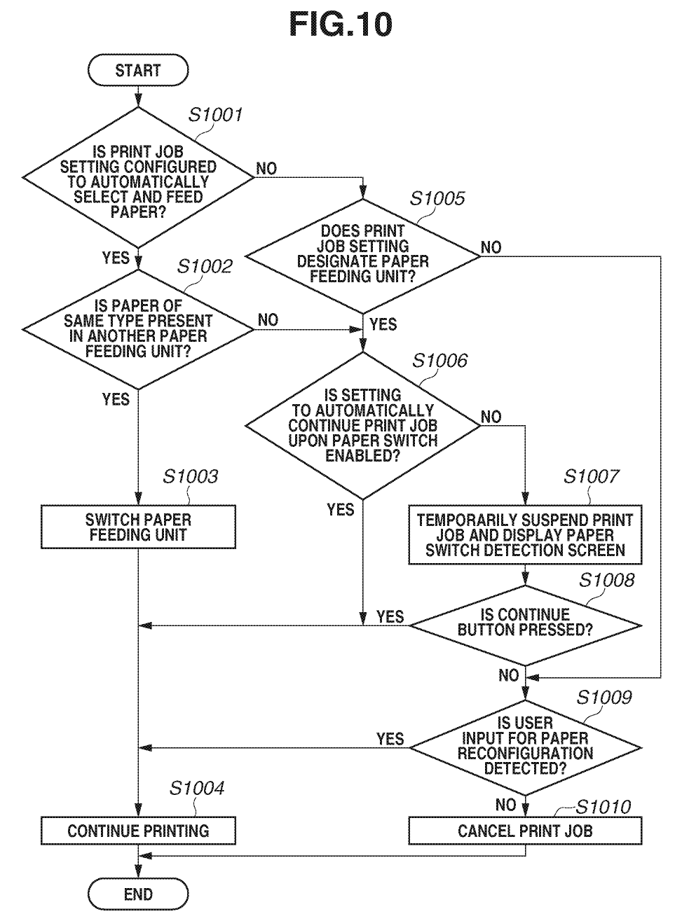

In step S617, the medium management program 406 determines whether to continue printing. It should be noted that the process of step S617 will be described in detail below with reference to FIG. 10.

Then, the medium management program 406 ends the series of processes illustrated in FIG. 6.

It should be noted that three or more paper types may be mixed as a result of repeating the series of processes illustrated in FIG. 6.

The screen configured to warn the user upon detecting a paper type mismatch and prompt the user to select whether to permit mixed paper and the screen configured to instruct the user to remove the paper and configure the setting in a case where mixed paper is not permitted, which are described above in the description of the processes of steps S606 to S608 illustrated in FIG. 6, will be described with reference to FIGS. 7A and 7B.

First, FIG. 7A will be described.

A Mixed Paper Detected screen 700 is a screen configured to notify the user that the plurality of paper types is mixed within the same paper feeding unit.

A first paper feeding unit information display field 701 is an area configured to briefly display paper size information and paper type information about the first paper feeding unit 229 of the MFP 101. In the example illustrated in FIG. 7A, it is indicated that different types of A4-size paper are stacked.

A paper feeding unit detailed information display field 702 is an area configured to display paper type information and remaining amount information about the first paper feeding unit 229 of the MFP 101. In the example illustrated in FIG. 7A, it is indicated that in the first paper feeding unit 229, plain paper 1 is stacked in an upper portion to 32% of a maximum load capacity and thick paper 1 is stacked in a lower portion to 35% of the maximum load capacity.

In a case where an operation on a mixed paper permission button 703 is received, stacking different paper types in the same paper feeding unit 229 is permitted, and paper information about the first paper feeding unit 229 is updated to the displayed state of the first paper feeding unit 229.

In a case where an operation on a mixed paper prohibition button 704 is received, stacking different paper types in the same paper feeding unit 229 is prohibited, and a transition to the screen illustrated in FIG. 7B occurs.

Next, FIG. 7B will be described.

A paper removal instruction screen 705 is configured to prompt the user to remove the paper from the first paper feeding unit 229 and reconfigure the paper setting in a case where mixed paper in the same paper feeding unit 229 is prohibited.

In a case where an operation on a paper removal message acknowledgement button 706 is received, paper information about the target paper feeding unit 229 is reset, and the paper removal instruction screen 705 is closed.

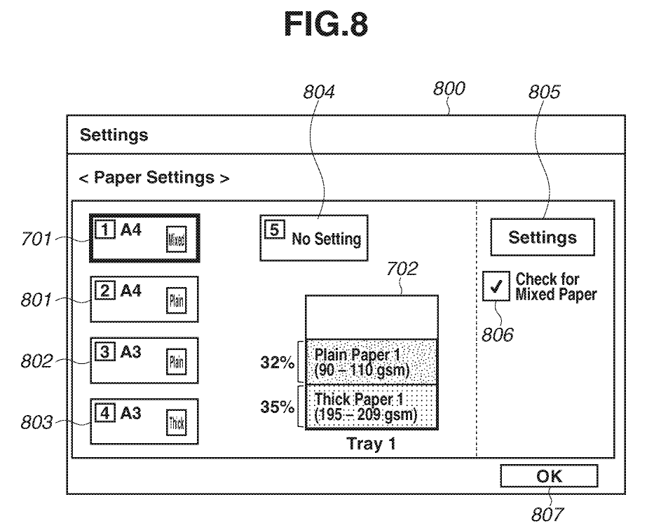

An example of a paper setting screen of the paper feeding device 220 for a case where mixed paper is permitted, which is described above in the description of step S606 illustrated in FIG. 6, will be described with reference to FIG. 8.

A paper setting screen 800 is a screen configured to configure a setting for each paper feeding unit and includes a field where information about each paper feeding unit is displayed and another field where detailed information about a selected paper feeding unit is displayed. In the example illustrated in FIG. 8, a state where the first paper feeding unit information display field 701 is selected is illustrated.

A second paper feeding unit information display field 801 is an area configured to briefly display paper size information and paper type information about the second paper feeding unit 230 of the MFP 101. In the example illustrated in FIG. 8, it is indicated that A4-size plain paper is stacked.

A third paper feeding unit information display field 802 is an area configured to briefly display paper size information and paper type information about the third paper feeding unit 231 of the MFP 101. In the example illustrated in FIG. 8, it is indicated that A3-size plain paper is stacked.

A fourth paper feeding unit information display field 803 is an area configured to briefly display paper size information and paper type information about the fourth paper feeding unit 232 of the MFP 101. In the example illustrated in FIG. 8, it is indicated that A3-size thick paper is stacked.

A fifth paper feeding unit information display field 804 is an area configured to briefly display paper size information and paper type information about the fifth paper feeding unit 233 of the MFP 101. In the example illustrated in FIG. 8, it is indicated that no paper is set.

In a case where an operation on a paper setting change button 805 is received, a transition to a screen configured to change a paper setting for the selected paper feeding unit occurs.

A mixed paper confirmation enabling/disabling field 806 is a checkbox configured to receive a user instruction indicating whether to confirm whether paper of a type different from the set paper type is stacked in the selected paper feeding unit. In a case where the checkbox is not checked, the series of processes for mixed paper confirmation described above with reference to FIG. 6 is not performed on the target paper feeding unit.

In a case where an operation on a paper setting completion button 807 is received, the paper setting screen 800 is closed.

An example of each screen described above in the description of steps S611 and S615 illustrated in FIG. 6 will be described with reference to FIGS. 9A to 9C.

First, an example of a paper switch warning screen presented in a case where the remaining amount of replenished paper becomes low and the paper type will be switched shortly will be described with reference to FIG. 9A.

A paper switch warning screen 900 is a screen configured to notify the user that the paper type will be switched shortly. The paper switch warning screen 900 is displayed in a case where the remaining amount of paper stacked in the uppermost portion in the paper feeding unit containing different paper types becomes equal to a minimum unit detectable by a minimum unit detection function of the paper feeding device 220.

In a case where an operation on a paper switch warning screen close button 901 is received, the paper switch warning screen 900 is closed.

Next, an example of a paper switch detection screen presented in a case where the replenished paper has been depleted and switched to the paper stacked before the replenishment will be described with reference to FIG. 9B.

A paper switch detection screen 902 is a screen displayed in a case where the type of paper in the paper feeding unit containing different paper types has been switched and printing is continued with the switched paper. The paper switch detection screen 902 notifies the user that print quality may change, and prompts the user to select whether to continue printing with the switched paper or designate another type of paper.

In a case where an operation on a print continuation button 903 is received, printing is continued with the switched paper.

In a case where an operation on a paper setting reconfiguration button 904 is received, the paper setting screen 800 is displayed to prompt the user to reconfigure the paper setting.

Next, an example of a paper setting reconfiguration screen for reconfiguring the paper setting to continue printing will be described with reference to FIG. 9C.

A paper setting reconfiguration screen 905 is a screen configured to prompt the user to reconfigure the paper setting and has a basic configuration similar to that of the paper setting screen 800 described above with reference to FIG. 8. The paper setting reconfiguration screen 905 is different from the paper setting screen 800 in that the mixed paper confirmation enabling/disabling field 806 is not included while a job cancellation button 906 is included.

In a case where an operation on the job cancellation button 906 is received, the print job is stopped without reconfiguring the paper setting.

Details of the process of determining whether to continue printing in step S617 in FIG. 6 will be described with reference to FIG. 10. It should be noted that the series of processes illustrated in FIG. 10 is realized by executing the job management program 504 based on an instruction from the medium management program 406. Specifically, the series of processes illustrated in FIG. 10 is realized by the CPU 301 of the DFE 103 by reading the job management program 504 stored in the ROM 303 or the like and executing the job management program 504. Accordingly, while the CPU 301 is the entity that actually performs the series of processes illustrated in FIG. 10, for convenience, the job management program 504 will be described as the entity of each process.

In step S1001, the job management program 504 determines whether a print job setting is configured to automatically select and feed paper.

In a case where the job management program 504 determines that the print job setting is configured to automatically select and feed paper (YES in step S1001), the processing proceeds to step S1002.

On the other hand, in a case where the job management program 504 determines that the print job setting is not configured to automatically select and feed paper (NO in step S1001), the processing proceeds to step S1005.

In step S1002, the job management program 504 determines whether paper of the same type as the previously fed paper is present in another paper feeding unit different from the paper feeding unit on which paper type detection has been performed.

In a case where the job management program 504 determines that paper of the same type as the previously fed paper is present in the target paper feeding unit (YES in step S1002), the processing proceeds to step S1003.

On the other hand, in a case where the job management program 504 determines that paper of the same type as the previously fed paper is not present (paper of a different type is present) in the target paper feeding unit (NO in step S1002), the processing proceeds to step S1006.

In step S1003, the job management program 504 switches the paper feed destination to the targe paper feeding unit on which it is determined in step S1002 whether paper of the same type is present.

In step S1004, the job management program 504 continues printing and ends the series of processes illustrated in FIG. 10.

In step S1005, the job management program 504 determines whether the print job setting explicitly designates a paper feeding unit to which paper is fed.

In a case where the job management program 504 determines that the print job setting explicitly designates a paper feeding unit to which paper is fed (YES in step S1005), the processing proceeds to step S1006.

On the other hand, in a case where the job management program 504 determines that the print job setting does not explicitly designate a paper feeding unit to which paper is fed (NO in step S1005), the processing proceeds to step S1009.

In step S1006, the job management program 504 determines whether a setting to automatically continue the print job upon a paper type switch is enabled.

In a case where the job management program 504 determines that the setting to automatically continue the print job upon a paper type switch is enabled (YES in step S1006), the processing proceeds to step S1004.

On the other hand, in a case where the job management program 504 determines that the setting to automatically continue the print job upon a paper type switch is not enabled (NO in step S1006), the processing proceeds to step S1007.

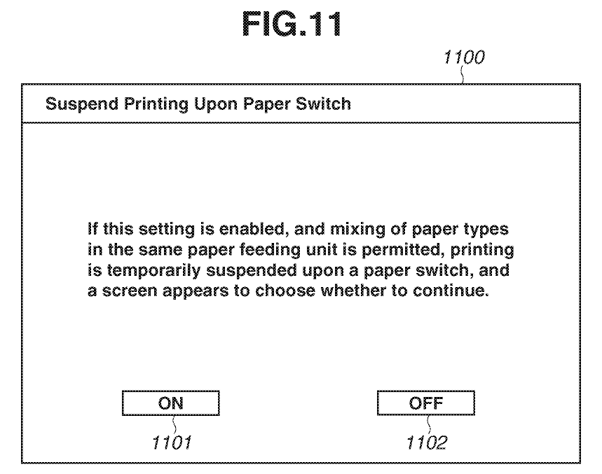

It should be noted that an example of a screen configured to enable or disable the setting to automatically continue the print job upon a paper type switch is enabled will be described below with reference to FIG. 11.

In step S1007, the job management program 504 temporarily suspends the print job and displays a paper switch detection screen 902.

In step S1008, the job management program 504 awaits user input on the print continuation button 903 or the paper setting reconfiguration button 904 on the paper switch detection screen 902.

In a case where the job management program 504 detects a press of the print continuation button 903 (YES in step S1008), the processing proceeds to step S1004.

On the other hand, in a case where the job management program 504 detects a press of the paper setting reconfiguration button 904 (NO in step S1008), the processing proceeds to step S1009.

In step S1009, the job management program 504 displays the paper setting reconfiguration screen 905 and awaits user input for paper setting reconfiguration or user input on the job cancellation button 906.

In a case where the job management program 504 detects user input for paper setting reconfiguration (YES in step S1009), the processing proceeds to step S1004.

On the other hand, in a case where the job management program 504 detects a press of the job cancellation button 906 (NO in step S1009), the processing proceeds to step S1010.

In step S1010, the job management program 504 cancels the print job and ends the series of processes illustrated in FIG. 10.

FIG. 11 illustrates an example of a screen that is displayed during the process of step S1006 in FIG. 10 and prompts the user to select whether to continue printing automatically or suspend printing upon a paper type switch in a situation where the same paper feeding unit of the paper feeding device 220 contains different paper types.

A Suspend Upon Paper Switch setting screen 1100 is a screen for switching the above-described setting.

In a case where an input operation on a printing suspension enabling button 1101 is received, printing is temporarily suspended upon a paper switch in the situation where the same paper feeding unit of the paper feeding device 220 contains different paper types.

In a case where an input operation on a printing suspension disabling button 1102 is received, printing is continued with switched paper upon a paper switch in the situation where the same paper feeding unit of the paper feeding device 220 contains different paper types.

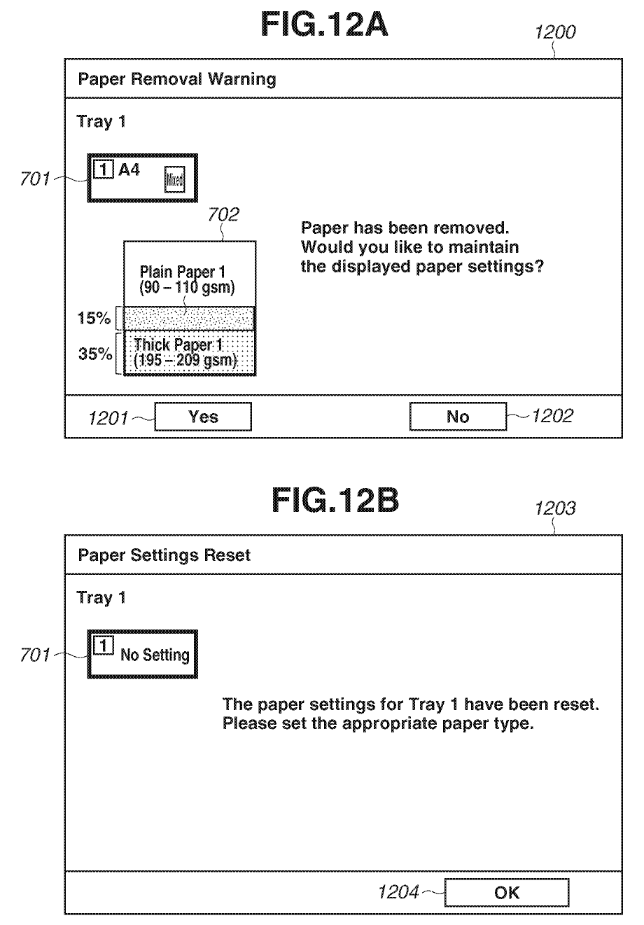

FIGS. 12A and 12B illustrate examples of screens configured to prompt the user to select whether to maintain the paper type setting when paper is removed from the paper feeding unit in the situation where the same paper feeding unit of the paper feeding device 220 contains different paper types.

First, FIG. 12A will be described.

A paper removal warning screen 1200 is a screen displayed in a case where paper is removed from the paper feeding unit containing different paper types by the user. It should be noted that, for example, the medium management program 406 may determine the paper-removed state by the user by detecting the opening of the paper feeding unit and a decrease in the remaining amount of paper. At that time, the paper feeding unit detailed information display field 702 displays paper information about the target paper feeding unit after the paper removal.

In a case where an input operation on a paper setting state maintenance button 1201 is received, the paper information about the paper feeding unit after the paper removal is maintained.

In a case where an input operation on a paper setting state initialization button 1202 is received, the paper information about the target paper feeding unit is initialized. Then, to a transition a paper setting initialization completion screen 1203, which will be described with reference to FIG. 12B, occurs.

Next, FIG. 12B will be described.

The paper setting initialization completion screen 1203 is a screen configured to notify the user that the paper setting is initialized.

In a case where an input operation on a paper setting initialization completion confirmation button 1204 is received, the paper setting initialization completion screen 1203 is closed.

As described above, according to the present embodiment, even in a case where a plurality of paper types is stacked in the same paper feeding unit due to user error, remaining amount information for each paper type is displayed appropriately, thereby making it possible to output a desired printed material.

### Second Embodiment

In the first embodiment, a method is described in which even in a case where a plurality of paper types is stacked in the same paper feeding unit due to user error, paper information is displayed appropriately, thereby performing printing appropriately. However, there are cases where the user intentionally stacks a plurality of paper types in the same paper feeding unit and wishes to set the state for the system. In such cases, it is desirable to allow the plurality of paper types to be set for the same paper feeding unit, for example, by a user operation. Accordingly, in a second embodiment of the present disclosure, an example of a process for setting a plurality of paper types for the same paper feeding unit and an example of a user setting screen will be described.

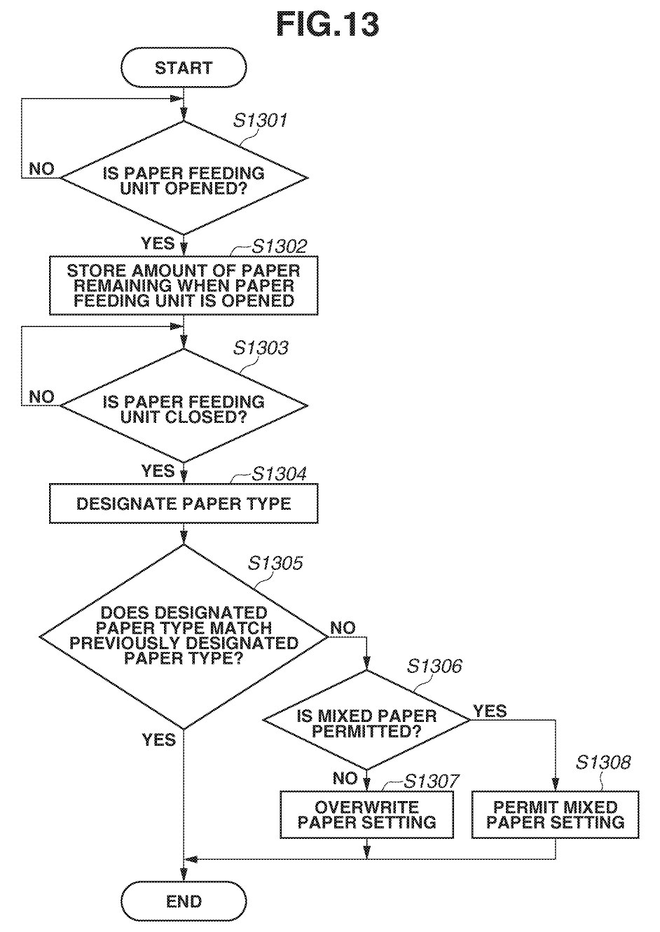

An example of a process of the MFP 101 according to the present embodiment will be described with reference to FIG. 13. Specifically, FIG. 13 illustrates an example of a process in which in a case where the medium management program 406 determines that a paper type different from the previously set paper type is designated for the same paper feeding unit of the paper feeding device 220, the medium management program 406 determines whether to permit the mixed paper state or overwrite the paper setting. It should be noted that the series of processes illustrated in FIG. 13 is realized by the controller unit 205 of the MFP 101 by reading the medium management program 406 stored in the ROM 207 or the like and executing the medium management program 406. Accordingly, while the controller unit 205 is the entity that actually performs the series of processes illustrated in FIG. 13, for convenience, the medium management program 406 will be described as the entity of each process.

In step S1301, the medium management program 406 determines whether a paper feeding unit is opened.

Unless the medium management program 406 determines that a paper feeding unit is opened in step S1301, the medium management program 406 repeats the process of step S1301.

Then, in a case where the medium management program 406 determines that a paper feeding unit is opened (YES in step S1301), the processing proceeds to step S1302.

In step S1302, the medium management program 406 stores the amount of paper remaining in the paper feeding unit at the time the paper feeding unit is opened. At that time, the information indicating the amount of remaining paper is saved in a non-volatile storage area, such as the HDD 209, because the information should be held even in a case where the MFP 101 is re-activated.

In step S1303, the medium management program 406 determines whether the paper feeding unit is closed.

Unless the medium management program 406 determines that the paper feeding unit is closed in step S1303, the medium management program 406 repeats the process of step S1303.

Then, in a case where the medium management program 406 determines that the paper feeding unit is closed (YES in step S1303), the processing proceeds to step S1304.

It should be noted that while whether paper replenishment has been performed is determined based on whether the paper feeding unit has been opened and closed, as described in the processes of steps S1301 to S1303 in the present embodiment, in addition to the foregoing control, another control may be applied in which whether paper replenishment has been performed is determined based on an increase in the amount of paper remaining in the paper feeding unit upon closing the paper feeding unit.

In step S1304, the medium management program 406 awaits user input regarding the paper type setting for the target paper feeding unit. Upon receiving user input regarding the paper type setting, the processing proceeds to step S1305.

In step S1305, the medium management program 406 determines whether the paper type designated in step S1304 matches the previously designated paper type.

In a case where the medium management program 406 determines that the paper type designated in step S1304 matches the previously designated paper type (YES in step S1305), the medium management program 406 ends the series of processes illustrated in FIG. 13.

On the other hand, in a case where the medium management program 406 determines that the paper type designated in step S1304 does not match the previously designated paper type (NO in step S1305), the processing proceeds to step S1306.

In step S1306, the medium management program 406 displays a screen configured to prompt the user to select whether to permit mixed paper. Thereafter, the medium management program 406 receives an input operation from the user via the screen to select whether to permit mixed paper.

In a case where the medium management program 406 determines that an input operation indicating that mixed paper is permitted is received (YES in step S1306), the processing proceeds to step S1308.

On the other hand, in a case where the medium management program 406 determines that an input operation indicating that mixed paper is not permitted is received (NO in step S1306) the processing proceeds to step S1307.

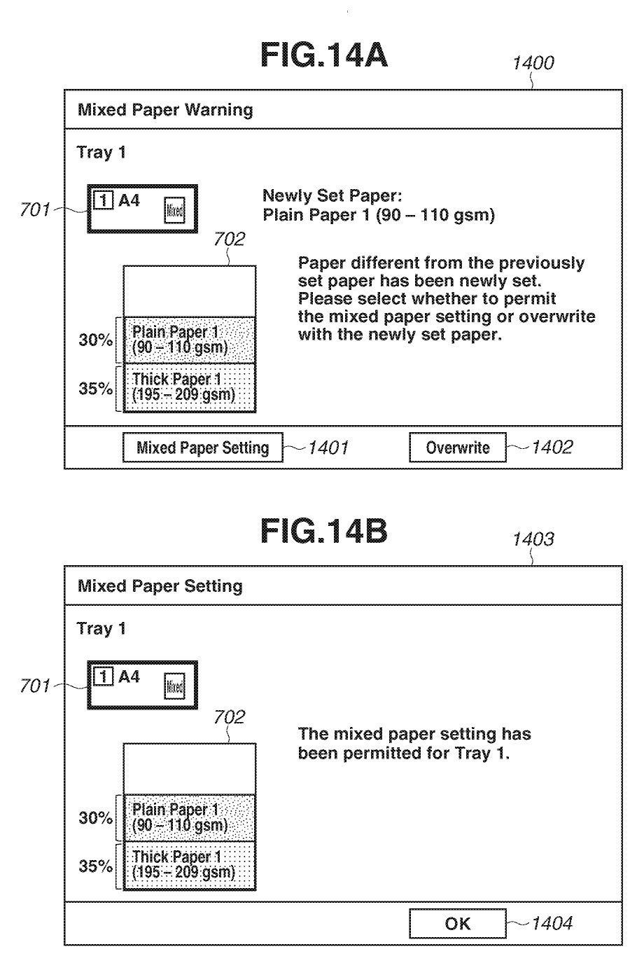

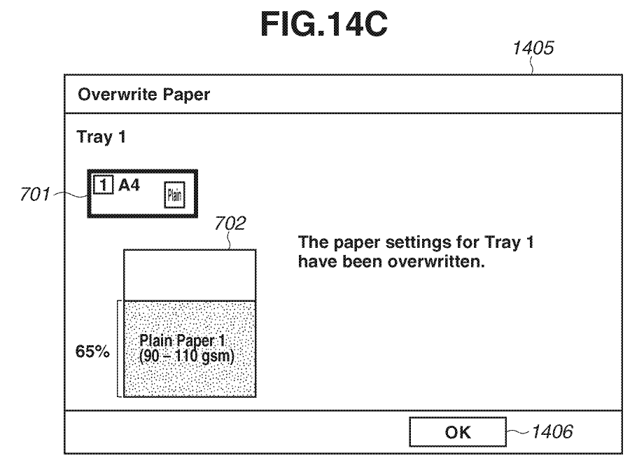

It should be noted that the screen displayed in step S1306 will be described in detail below with reference to FIG. 14A.

In step S1307, the medium management program 406 displays a screen configured to notify the user that the paper setting for the target paper feeding unit has been overwritten with the newly designated paper type without permitting mixed paper. Upon displaying the screen, the medium management program 406 ends the series of processes illustrated in FIG. 13. It should be noted that the screen displayed in step S1307 will be described in detail below with reference to FIG. 14C.

In step S1308, the medium management program 406 displays a screen configured to notify the user that mixed paper is permitted and the paper setting for the target paper feeding unit is complete. Upon displaying the screen, the medium management program 406 ends the series of processes illustrated in FIG. 13. It should be noted that the screen displayed in step S1308 will be described in detail below with reference to FIG. 14B.

It should be noted that three or more paper types may be mixed in the same paper feeding unit as a result of repeating the series of processes illustrated in FIG. 13.

FIGS. 14A to 14C illustrate examples of the screens displayed in steps S1306, S1307, and S1308 illustrated in FIG. 13.

First, the setting screen displayed during the process of step S1306 in FIG. 13 to determine whether to maintain the mixed paper setting or overwrite with the newly set paper type in a case where the mixed paper setting is set will be described with reference to FIG. 14A.

A mixed paper warning screen 1400 is a screen configured to notify the user that a paper type different from the previously set paper type is newly designated for the same paper feeding unit of the paper feeding device 220.

In a case where an input operation on a mixed paper permission button 1401 is received, mixed paper is permitted in the target paper feeding unit, and the paper information displayed in the paper feeding unit detailed information display field 702 on the mixed paper warning screen 1400 is set for the paper feeding unit.

In a case where an input operation on a paper setting overwriting button 1402 is received, mixed paper is prohibited in the target paper feeding unit, and the information about the paper feeding unit is overwritten with the newly set paper type. Then, once the setting is configured, a transition to a paper setting overwriting completion screen 1405, which will be described below with reference to FIG. 14C, occurs.

Next, an example of a screen displayed during the process of step S1307 in FIG. 13 in a case where mixed paper is permitted will be described with reference to FIG. 14B.

A mixed paper setting completion screen 1403 is a screen configured to notify the user that configuration of the mixed paper setting for the target paper feeding unit is complete.

In a case where an input operation on a mixed paper setting completion confirmation button 1404 is received, the mixed paper setting completion screen 1403 is closed.

Next, an example of a screen displayed during the process of step S1308 in FIG. 13 in a case where overwriting the paper setting is permitted will be described with reference to FIG. 14C.

The paper setting overwriting completion screen 1405 is a screen configured to notify the user that overwriting of the paper setting for the target paper feeding unit has been completed.

In a case where an input operation on a paper setting overwriting completion confirmation button 1406 is received, the paper setting overwriting completion screen 1405 is closed.

As described above, according to the present embodiment, in a case where the user wishes to configure the mixed paper setting for the same paper feeding unit, the mixed paper setting is realized first, and then the remaining amount information for each paper type is displayed appropriately, thereby making it possible to output a desired printed material.

Further, various modifications may be applied without departing from the basic technical concept of each embodiment described above.

While an example of a case where the series of processes illustrated in FIG. 6 is performed by the MFP 101 is described as a specific example in the above-described embodiment, the example is not intended to limit the entity that performs the series of processes. As a specific example, the series of processes illustrated in FIG. 6 may be performed by another apparatus configured to cooperate with the MFP 101 (for example, an information processing apparatus configured to communicate with the MFP 101). In that case, the other apparatus may perform various processes described above with reference to FIG. 6 based on the state of the MFP 101 and various detection results obtained by the MFP 101 (for example, detection results such as the paper-feeding status of the paper feeding unit and paper type). The same applies to the series of processes illustrated in FIG. 13.

Further, as another example, the entity that performs the series of processes illustrated in FIG. 10 is not necessarily limited to the DFE 103. As a specific example, another apparatus different from the DFE 103 may perform at least some of the series of processes illustrated in FIG. 10.

The present disclosure enables printing to be performed more suitably even in a situation where a target paper feeding unit contains different types of paper.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033748, filed Mar. 4, 2025, which is hereby incorporated by reference herein in its entirety.

What is claimed is:

1. An information processing apparatus comprising:
at least one memory storing instructions; and
at least one processor that, upon execution of the stored instructions, configures the at least one processor to operate as:
a paper replenishment determination unit configured to determine whether paper has been replenished in a paper feeding unit configured to feed paper to an image forming unit configured to form an image on the paper,
a remaining paper amount determination unit configured to determine a remaining amount of paper in the paper feeding unit,
a paper type determination unit configured to determine a type of the paper fed from the paper feeding unit; and
a notification unit configured to notify a user of a remaining amount of paper stacked in the paper feeding unit for each type and a switch in the type of the paper fed from the paper feeding unit in a case where the paper replenishment determination unit determines that paper has been replenished in the paper feeding unit and a result of determining a type of the replenished paper in the paper feeding unit by the paper type determination unit is different from a type of the paper stacked in the paper feeding unit prior to the replenishment.

2. The information processing apparatus according to claim 1, wherein in a case where the remaining amount of the replenished paper in the paper feeding unit becomes less than or equal to a threshold, the paper type determination unit starts determining the type of the paper fed from the paper feeding unit, and in a case where the switch in the type of the paper fed from the paper feeding unit is detected, the paper type determination unit stops determining the type of the paper fed from the paper feeding unit.

3. The information processing apparatus according to claim 2, wherein in the case where the switch in the type of the paper fed from the paper feeding unit is detected by the paper type determination unit, the notification unit notifies the user of the switch in the type of the paper.

4. The information processing apparatus according to claim 1, wherein in a case where the remaining amount of the replenished paper in the paper feeding unit becomes less than or equal to a threshold, the notification unit notifies the user of an occurrence of the switch in the type of the paper fed from the paper feeding unit.

5. The information processing apparatus according to claim 2, wherein the threshold is a minimum detectable unit of change in the remaining amount of the stacked paper in the paper feeding unit.

6. The information processing apparatus according to claim 1, further comprising a storage unit configured to store the remaining amount of the paper prior to the replenishment of the paper in the paper feeding unit determined by the remaining paper amount determination unit in the case where the paper replenishment determination unit determines that paper has been replenished in the paper feeding unit,
wherein a remaining amount of the replenished paper in the paper feeding unit is determined based on a result of comparing the remaining amount stored in the storage unit and the remaining amount of the paper stacked in the paper feeding unit.

7. The information processing apparatus according to claim 1, wherein paper is fed from the paper feeding unit after the replenishment of the paper in the paper feeding unit, and whether the type of the replenished paper in the paper feeding unit is different from the type of the paper stacked in the paper feeding unit prior to the replenishment is determined based on a type of the fed paper determined by the paper type determination unit.

8. The information processing apparatus according to claim 1, wherein whether the paper type determination unit determines the type of the replenished paper in the paper feeding unit is determined based on an instruction from the user.

9. The information processing apparatus according to claim 1, wherein whether to continue printing automatically or suspend printing in a case where a switch in the type of the paper fed from the paper feeding unit is detected is selected based on an instruction from the user.

10. A method for controlling an information processing apparatus, the method comprising:
determining whether paper has been replenished in a paper feeding unit configured to feed paper to an image forming unit configured to form an image on the paper;
determining a remaining amount of paper in the paper feeding unit;
determining a type of the paper fed from the paper feeding unit; and
notifying a user of a remaining amount of paper stacked in the paper feeding unit for each type and a switch in the type of the paper fed from the paper feeding unit in a case where it is determined that paper has been replenished in the paper feeding unit and a result of determining a type of the replenished paper in the paper feeding unit is different from a type of the paper stacked in the paper feeding unit prior to the replenishment.

11. A non-transitory computer readable storage medium storing a program for causing a computer to perform a method, the method comprising:
determining whether paper has been replenished in a paper feeding unit configured to feed paper to an image forming unit configured to form an image on the paper;
determining a remaining amount of paper in the paper feeding unit;
determining a type of the paper fed from the paper feeding unit; and
notifying a user of a remaining amount of paper stacked in the paper feeding unit for each type and a switch in the type of the paper fed from the paper feeding unit in a case where it is determined that paper has been replenished in the paper feeding unit and a result of determining a type of the replenished paper in the paper feeding unit is different from a type of the paper stacked in the paper feeding unit prior to the replenishment.
